(19) United States
(12) Patent Application Publication
(10) Pub. No.: US 2009/0294215 A1
(43) Pub. Date: Dec. 3, 2009

(54) ADAPTERS FOR AERIAL WORK PLATFORMS

(76) Inventor: Donald Joseph Vos, Shadow Hills, CA (US)

Correspondence Address: BLANK ROME LLP, WATERGATE, 600 NEW HAMPSHIRE AVENUE, N.W., WASHINGTON, DC, 20037, US

(21) Appl. No.: 12/130,314

(22) Filed: May 30, 2008

(51) Int. Cl. E04G 1/18; F16B 7/00

(52) U.S. Cl. 182/141; 182/222; 403/188

(57) ABSTRACT

An aerial work platform apparatus includes a platform adapted to be attached to one end of a boom or a lifting system and a frame coupled to the platform. The frame has a plurality of vertical and horizontal rails, and a plurality of adapters, each adapter being integrally attached to one of the vertical and horizontal rails and receives and secures a tube to the rail. Each adapter includes a sleeve for receiving the tube, at least one fastener for securing the tube to the sleeve, and a connecting unit for integrally connecting the sleeve to the frame.

### FIELD OF THE INVENTION

The present invention relates to adapters for aerial work platforms such as boom baskets or cherry pickers. More particularly, the present invention relates to adapters welded to a frame of an aerial work platform for receiving support poles used to secure various accessories and equipment.

### DESCRIPTION OF RELATED ART

Aerial work platform assemblies are well known devices for lifting workers or equipment to elevated work areas. In the entertainment or filming industry, boom baskets are commonly used as the aerial work platforms to carry cameramen, cameras, accessories and equipment to elevated work sites.

Aerial platforms are shown, for instance, in U.S. Pat. Nos. 7,182,173 and 5,683,063. As shown, the platform includes a boom and a work platform. One end of the boom is usually mounted to a vehicle or mobile chassis. The other end of the boom is attached to the work platform. A controller raises the end of the boom that is attached to the work platform to a desired aerial work site. The work platform, typically called a “boom basket,” includes a floor, horizontal rails and spaced vertical bars; all of which are interconnected to form a basket-shaped work space.

To attach lighting equipment to the boom basket, poles or tubes, commonly called “speedrails” in the entertainment industry, have been secured to the vertical bars or horizontal rails of the boom basket with rope or vice grip chain clamps. The lighting equipment is then attached to the poles or tubes. Similarly, to attach light reflectors, which are sometimes called “flyswatters” in the entertainment industry, to the boom basket, poles that are part of the reflectors are tied to the horizontal rails of the boom basket with rope or vice-grip chain clamps. Numerous other apparatus and equipment have also been attached to the boom basket or aerial work platforms in a similar fashion using rope or vice grip chain clamps.

However, the use of rope to tie the support poles to the boom basket is not very secure and can be awkward and inconvenient. In addition, attachments using ropes or the like do not always yield satisfactory results. The vice-grip chain clamps are also not very secure as a means to attach filming accessories to the boom basket. They can become dislodged, which is unsafe to the users of the boom basket or those standing or working beneath the boom basket.

### SUMMARY OF THE INVENTION

It is therefore an object of this invention to provide an improved aerial work platform that overcomes some of the problems and shortcomings of the prior art. In particular, it is an object to provide a boom basket to which support poles for accessories and equipment can be attached securely, easily, and conveniently. Another object of the invention is to provide a work platform to which the accessories and equipment can be attached more securely than what the rope and chain clamps can provide, hence enhancing safety for workers or bystanders underneath the work platform. Another object of the invention is to provide an improved adapter for receiving and securing poles to a work platform.

According to an exemplary embodiment of the present invention, an aerial work platform apparatus is provided. The aerial work platform includes a platform adapted to be attached to one end of a boom and a frame coupled to the platform. The adapter includes at least one adapter integrally attached to the frame and receives and secures a tube to the frame.

According to another exemplary aspect of the present invention, an aerial work platform apparatus is provided. The aerial work platform apparatus includes a platform adapted to be attached to one end of a boom or a lifting system and a frame coupled to the platform. The frame includes a plurality of vertical and horizontal rails and a plurality of adapters, each adapter being integrally attached to one of the vertical and horizontal rails and receives and secures a tube to the rail that the adapter is integrally attached to.

According to another exemplary embodiment of the present invention, there is provided an adapter for receiving and securing a tube to a frame. The adapter has a sleeve for receiving the tube, at least one fastener for securing the tube to the sleeve, and a connecting unit for integrally connecting the sleeve to the frame. The connecting unit has first and second brackets, wherein the first bracket is integrally attached to the sleeve and the second bracket is integrally attached to the first bracket and to the frame.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 shows a perspective view illustrating a boom basket assembly in accordance with one exemplary embodiment of the present invention;

FIG. 2 shows an up-close view of an adapter in FIG. 1 in accordance with another exemplary embodiment of the present invention;

FIG. 3 shows an exploded view of an adapter in accordance with yet another exemplary embodiment of the present invention; and

FIG. 4 shows a prior art connector for two perpendicular tubes.

### DETAILED DESCRIPTION OF THE PREFERRED EMBODIMENTS

Preferred embodiments of the invention will be set forth in detail with reference to the drawings, in which like reference numerals refer to like elements or steps throughout.

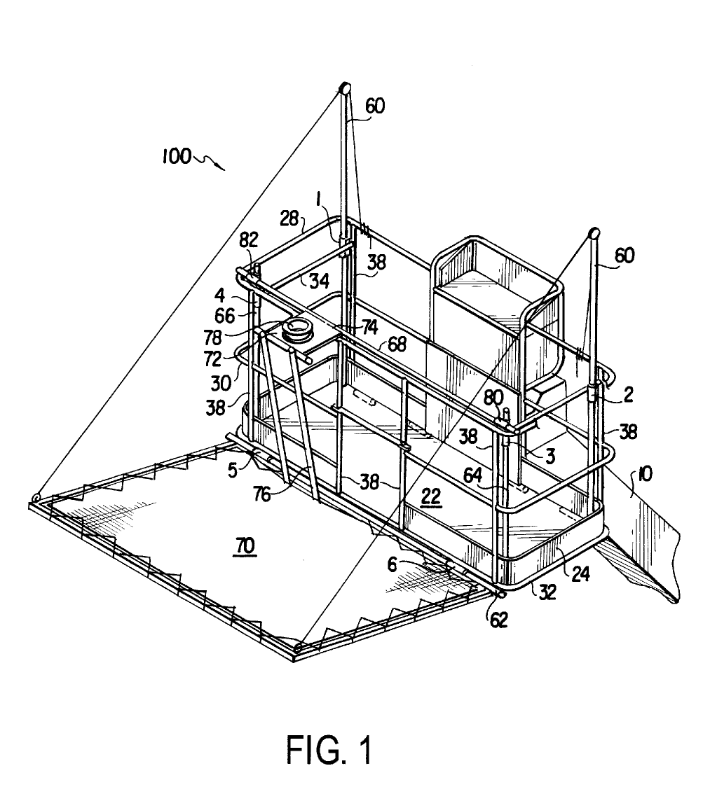

FIG. 1 is a perspective view of a boom basket assembly 100 in accordance with one exemplary embodiment of the present invention. The assembly 100 includes a boom 10, an aerial work platform generally indicated as 20, adapters 1-6, and elongated support members 60, 62, 64, 66, and 68.

In the preferred embodiment, the aerial work platform 20 is a boom basket which includes a floor 22, a kickboard 24 around the periphery of the floor 22, and a frame 26. The adapters 1-6 are integrally and permanently attached to various locations on the frame 26. The frame 26 includes a horizontal top rail 28, a horizontal mid rail 30, and a horizontal bottom rail 32. The top, mid, and bottom rails 28, 30, and 32 have a rectangular shape formed by longer sides at the front and back of the boom basket 20, and shorter sides on the side of the boom basket 20. In addition, the rectangular top rail 28 also has cross-members 34 and 36 having substantially the same length as the shorter sides for connecting the two longer sides of the top rail 28.

The frame 26 also includes vertical bars 38 that are interconnected with the top, mid, and bottom rails and the kickboard 24 at the periphery of the floor 22. The frame 26 is preferably made out of metal, but it can also be made out of any other sturdy material that provides safety for the users. The boom 10 holds and elevates the boom basket 20. The boom basket 20 receives workers and enables them to be positioned near the work area.

In the embodiment of FIG. 1, the adapters 1-4 are integrally and vertically attached to the top rail 28 of the frame 26 and the adapters 5 and 6 are integrally and horizontally attached to the front, longer side of the bottom rail 32. In addition, four adapters are shown attached to the rear bottom rail 32, opposite the adapters 5 and 6 (shown in dashed lines). The adapters 1-6 all have the same structures. The adapters 1-6 receive poles 60, 62, 64, 66, and 68 which in turn connect to accessories or equipment, such as the flyswatter 70 and the movie camera mount 72. The adapters 1-6 are integrally attached to the rails of boom basket, preferably by welding, such that they permanently and integrally become parts of the boom basket.

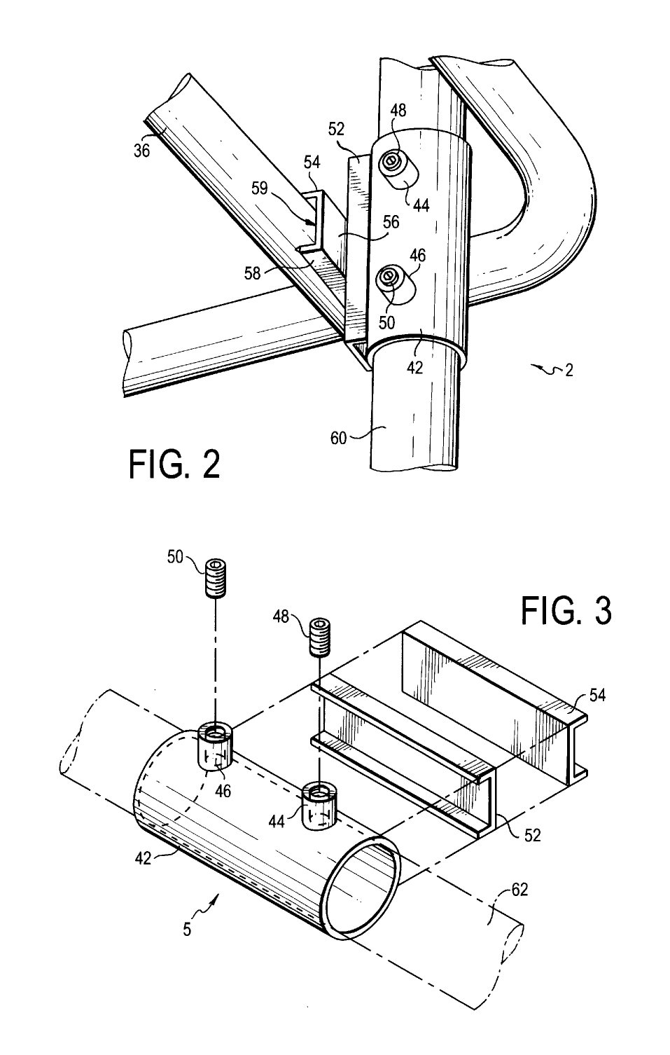

FIG. 2 shows the detail of the adapter 2 of FIG. 1 in accordance to another exemplary embodiment of the present invention. The adapter 2 can also be called a “speedrail receiver mount” for receiving and securing a speedrail to the boom basket. The adapter 2 includes a tubular sleeve 42, a first threaded boss 44, a second threaded boss 46, a first bolt 48, a second bolt 50, a first bracket 52, and a second bracket 54. The first bracket 52 and the second bracket 54 have similar rectangular shapes.

The first and second brackets 52, 54 have a rectangular hack 56 and two side walls 58 that extend substantially perpendicular to the back 56 to form a receiving channel 59 therebetween and form a U-shape cross-section. The side walls 58 of the brackets 52, 54 can be formed with the back 56 from a single piece of material. The first bracket 52 is attached to the sleeve 42 by positioning the outside of the sleeve 42 in the channel 59 and welding the ends of the side walls 58 to the sleeve 42 where the side walls 58 mate up against the sleeve 42. The back 56 of the first bracket 52 is attached to the back of the second bracket 54, preferably by welding. Likewise, the side walls 58 of the second bracket 54 are welded to the outside of the tube 36 of the top rail 28. Referring briefly back to FIG. 1, the adapters 1 and 4 are attached to the bar 34 of the top rail 28, and the adapters 2 and 3 are attached to the bar 36 of the top rail 28.

Once the bracket 52 is welded to the sleeve 42 and the bracket 54 to the tube 36, the elongated support tube 60 is slidably inserted into the opening in the sleeve 42 and fastened to the sleeve 42 by way of the bolts 48 and 50. The bolts 48 and 50 are screwed into the threaded bosses 44 and 46, respectively, through the sleeve and press the tube 60 against the sleeve 42 to fix the tube 60 into the sleeve 42. Thus, the adapter 2 connects the vertically extending tube 60 to horizontally extending tube 36. As shown, the first bracket 52 is substantially perpendicular to the second bracket 54 and the brackets 52 and 54 are centered with respect to each other to form a cross-shape. The perpendicular connection is used for each of the adapters 1-4 in FIG. 1, for instance.

Returning to FIG. 1, once the adapters 1-6 are attached to the frame 26, the elongated support members or tubes 60, 62, 64, and 66 can be received by the sleeve 42. For instance, a horizontal tube 62 is removably received by the sleeve 42 of the adapters 5, 6 at the bottom front of the platform 20. In addition, vertical tubes 60, 64, and 66 are shown slidably received in the adapters 1-4. Additional adapters can also be attached to the mid rail 30 to further support the tubes 60, 64, 66. The horizontal tube 62 can be an elongated support member that connects with a variety of accessories, such as a light reflector 70 typically used in the entertainment industry. The far end of the reflector 70 is attached by strings to the vertical tubes 60 received by the adapters 1, 2 to maintain the reflector 70 in the desired position. The tubes 60, 62, 64, and 66 connect with at least one adapter, but can connect to two or more for added stability, such as shown for adapters 5, 6 and the rear bottom adapters.

In addition, the first and second brackets 52, 54 can be configured to connect a horizontal frame to a horizontal tube, such as shown in FIG. 3, for adapters 5 and 6. The adapter 5 includes the sleeve 42, first boss 44, second boss 46, first screw 48, second screw 50, first bracket 52, and second bracket 54. The adapter 5 in FIG. 3 has the same structure as the adapter 40 shown in FIG. 2, except that in FIG. 2, the second bracket 54 is perpendicular to the first bracket 52, while in FIG. 3, the second bracket 54 is parallel to the first bracket 52. The sleeve 42 can be rotatably fixed to the first bracket 52 in a number of adjustable positions.

It should be understood by one skilled in the art that the sleeve 42, first bracket 52, and second bracket 54 may be oriented to any direction to accommodate the orientations of the rails and elongated members inserted into the sleeve 42. In general, it should be understood that the first and second brackets 52, 54 do not have to follow the direction of the sleeve or the rails of the frame of the boom basket. The first and second brackets 52, 54 can be orientated in any direction so long as they connect the sleeve to the frame. Because the sleeve 42 and bar 36 are round, the first and second brackets 52, 54 facilitate connection by having the channel 59 to receive their curved surfaces. It should also be understood that the first and second brackets 52, 54 may not be needed for the adapters. For instance, if the sleeve 42 and bar 36 are rectangular, the sleeve 42 can be directly, permanently and integrally attached to the bar 36.

In the present invention, the length of the sleeve of each of the adapters is approximately 4.5 inches, the inner diameter of the sleeve's opening is approximately 1¾ inches, and the length of the first and second brackets is approximately 4 inches. The sleeve and brackets of the adapter, however, may be of any desired size. Furthermore, the adapters may be made out of metal, plastic, or any other material that would allow an elongated support member to be inserted inside the sleeve. Furthermore, it is understood that some or all of the parts of the adapters may be molded or formed integrally as one piece. The adapters may also be formed as one integral piece with the rails of frame.

Regarding the adapters 3 and 4, FIG. 1 shows an example of a camera mount 72 being attached to the frame 26 using the adapters 3 and 4. The vertical tubes 64 and 66 are slidably received in, then fixed to, the sleeve 42 of the adapters 3 and 4, respectively, to thereby attach the tubes 64, 66 to the bars 34, 36. A tube 68, having a cross-section diameter between 1½ and 1¼ inches, is attached at one end to the tube 64 using a connector 80 and at the other end to the tube 66 using a connector 82. The camera mount 72 has a relatively horizontal top surface 74 attached to the tube 68. The tube 68 is selected to provide a secure attachment to the camera mount 72. The camera mount 72 has rounded feet at one end of the top surface 74. The rounded feet connect to the tube 68, which has a size between 1¼ and 1½ inches. The top rail 28 of the boom basket has a cross section between ½ and ¾ inches. Thus, the camera mount 72 is more secure when it is attached to the larger sized tube 68.

The camera mount 72 further has two support bars 76 connected to the top surface 74, opposite the rounded feet. The support bars 76 extend down to the bottom rail 32 to hold the top surface 74 in place. The top surface 74 is attached to the tube 68 by the feet, which clamp to the tube 68. The support bars 76 are attached to the bottom rail 32 with rope or clamps. A camera can rest on top of the top surface 74 by connecting to the camera connector 78 on surface 74.

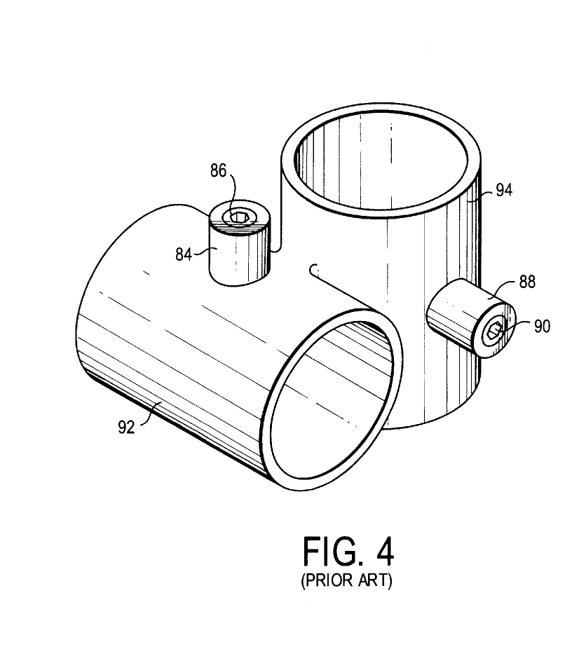

The connectors 80 and 82 can be any type of connectors known in the art for connecting two perpendicular tubes. FIG. 4 shows an example of a prior art connector that can be used. The connector in FIG. 4 is molded as one piece, including a first sleeve 92, a second sleeve 94 orthogonal to the first sleeve 92, first and second threaded bosses 84, 88, and first and second bolts 86, 90. In operation, the first sleeve 92 receives the tube 68 shown in FIG. 1 and the second sleeve receives the tube 64. The first bolt 86 is screwed into the first boss 84 to secure the tube 68 to the first sleeve 92. Similarly, the second bolt 90 is screwed into the second boss 88 to secure the tube 64 to the second sleeve 82.

In another configuration, instead of the adapters 3, 4, 80, 82 and tubes 64, 66, the adapters 3 and 4 can be attached to the top rail 28, thereby eliminating the adapters 80, 82 and tubes 64, 66 as done for tube 62. However, the configuration in FIG. 1 allows the tube 68 to be connected closer to its ends so the adapters 3, 4 do not obstruct where the camera mount 72 is connected to the tube 68.

FIG. 1 also shows a boom 10 attached at its one end to the boom basket 20. The boom 10 is part of a device that carries the boom basket 20 to a desired location above the ground. Any type of boom or lifting mechanism may be used, such as a scissor lift, within the scope of the invention.

In FIG. 1, the floor 22 of the boom basket 20 has a dimension of approximately 4 feet by 8 feet. However, the adapters in the present invention are not limited only to a boom basket or work platform of this size. The adapters may be integrally attached to the frame of an aerial work platform of any type or size, such as a cherry picker. In addition, the adapters 1-6 are integrally attached to various locations of the frame 26. Though preferably “welded,” it should be understood that any well known method of integrally attaching two elements together, including but not limited to forming two plastic elements together as one piece through molding, may be used.

The cross section of the support tubes 60-66 slidably received in the sleeve 42 of the adapters 1-6 can be any shape such as round, square, etc. The tubes can also be hollow or solid. The cross section of the sleeve 42 and the bar 36 are preferably round but can be square or another shape. Moreover, the adapters can have sleeves of different sizes so the tube sizes can be different. The brackets 52 and 54 can receive tubes of varying dimensions, including smaller bars 34, 36 and larger sleeve 42.

With the invention disclosed above, elongated support tubes such as the tubes 60-66 can be easily and quickly attached to the work platform 20. The permanent adapters such as those shown in FIGS. 2 and 3 provide stable and secure connections for the accessories and equipment to the boom basket, which enhances the safety for those working and standing beneath the boom basket. The manufacturer or user of the work platform also have the flexibility of connecting any number of adapters to the work platform 20 and any number of support tubes. Another flexibility is the adapters can be configured in different ways.

The permanent adapters disclosed herein can be used for any type of elevated work platform, including cherry pickers used by construction, telephone, and cable workers, or apparatus that are built by grip and lighting technicians in the entertainment industry. The flyswatter 70 and camera mount 72 are shown only for purposes of illustration of the invention. Any tubes, speedrails, or equipment with at least one support tube can be attached to the work platform using the disclosed adapters, such as the equipment that are used by the grip and lighting technicians for light diffusion, special effects, helicopter blade rigs, etc.

While certain exemplary embodiments of the present invention have been shown and described with reference to certain preferred embodiments thereof, it will be understood by those skilled in the art that various changes in form and details may be made therein without departing from the spirit and scope of the invention as defined by the appended claims and their equivalents.

We claim:

1. A work platform assembly, comprising:
a work platform;
a frame coupled to the platform; and
at least one adapter integrally attached to the frame for receiving and securing a tube to the frame.

2. The aerial work platform apparatus of claim 1, wherein the at least one adapter is integrally attached to the frame by being welded to the frame.

3. The aerial work platform apparatus of claim 1, wherein the at least one adapter includes a bracket which is welded to the frame.

4. The aerial work platform apparatus of claim 1, wherein the at least one adapter includes a first bracket and a second bracket, and wherein the first bracket is welded to the tube and the second bracket is welded to the frame.

5. The aerial work platform apparatus of claim 1, wherein the at least one adapter comprises a sleeve and at least one fastener, the sleeve being adapted to receive the tube therein and the at least one fastener being adapted to removably fasten the pole to the sleeve.

6. The aerial work platform apparatus of claim 5, wherein the at least one fastener is a bolt.

7. The aerial work platform apparatus of claim 6, wherein the at least one adapter further comprises a protrusion on the sleeve, having a threaded opening for receiving the bolt.

8. The aerial work platform apparatus of claim 1, wherein the at least one adapter further comprises:
a sleeve adapted to receive the tube;
a plurality of fasteners adapted to fasten the tube to the sleeve; and
a plurality of protrusions on the sleeve, each protrusion having an opening for receiving one of the plurality of fasteners.

9. An aerial work platform apparatus, comprising:
a platform adapted to be attached to one end of a boom;
a frame coupled to the platform, the frame comprising a plurality of vertical and horizontal rails; and
a plurality of adapters, each adapter being integrally attached to one of the vertical and horizontal rails for receiving a tube.

10. The aerial work platform apparatus of claim 9, wherein each of the plurality of adapters comprises:
a sleeve for receiving the tube;
a fastener for securing the tube to the sleeve;
a first bracket integrally attached to the sleeve; and
a second bracket integrally attached to the first bracket and to the frame.

11. An adapter for receiving and securing a tube to a frame, comprising of:
a sleeve for receiving the tube;
at least one fastener for securing the tube to the sleeve; and
a first bracket integrally attached to the sleeve, and a second bracket integrally attached to the first bracket and to the frame.

12. The adapter of claim 11, wherein the first bracket is perpendicular to the second bracket.

13. The adapter of claim 11, wherein the first bracket and the second bracket are elongated and parallel equal in size and attached on top of each other.

14. The adapter of claim 1, wherein the second bracket has a back and two side walls, the back and the two side walls forming a channel;
wherein a frame tube is received in the channel, and the two side walls are welded to the frame tube.
